(19) United States
(12) Patent Application Publication
(10) Pub. No.: US 2015/0377128 A1
(43) Pub. Date: Dec. 31, 2015

(54) NACELLE FOR AIRCRAFT, PROVIDED WITH A BUILT-IN SYSTEM FOR ANTI-ICING PROTECTION AND ACOUSTIC ABSORPTION

(71) Applicant: ALENIA AERMACCHI S.P.A., Venegono Superiore (IT)

(72) Inventor: Diego COPIELLO, Venegono Superiore (IT)

(21) Appl. No.: 14/758,048

(22) PCT Filed: Dec. 20, 2013
(86) PCT No.: PCT/IB2013/061177

§ 371 Date: Jun. 26, 2015

(30) Foreign Application Priority Data
Dec. 27, 2012 (IT) TO2012A001152

(51) Int. Cl. F02C 7/047; F01D 25/00; F01D 25/24; F02C 7/045

(52) U.S. Cl. CPC F02C 7/047; F02C 7/045; F01D 25/005; F01D 25/24; F05D 2260/96

(57) ABSTRACT

A nacelle (N) has a built-in system (10) for anti-icing protection and acoustic absorption and includes a casing or cowling (C), which has a substantially tubular shape and comprises an outer barrel (OB) and an inner barrel (IB), and a coupling edge or lip (L), which is frontally arranged and radially connects said barrels (OB, IB). The system (10) includes a panel structure (12) having electrically conductors (22), which are adapted to generate heat when they are flown through by an electric current, and a sound attenuating layer (18). The inner barrel (IB) houses the system (10).

### TECHNICAL FIELD

The present invention is relative to a nacelle for an aircraft, which is provided with a built-in system for anti-icing protection and acoustic absorption.

### TECHNOLOGICAL BACKGROUND

In the aeronautical field nacelles are known, namely substantially annular casings that have an aerodynamic profile and are adapted to contain, on the inside, an engine assembly of an aircraft.

On the one hand, the engine assemblies used in the aeronautical field are generally made up of several components and parts, which all contribute in a significant manner to the noise generated, both in terms of levels and in terms of frequencies to be attenuated. Therefore, nacelles are typically provided with elements for acoustic absorption (also called “acoustic panels”), which are suited to be mounted on aeronautical components and are manufactured so as to attenuate the noise that is typically generated during the operation of the aircraft.

On the other hand, when the nacelle is being used, ice tends to build up, in particular in correspondence to the so-called lip, mainly due to the presence of low-temperature flows of air. This situation can cause many harmful drawbacks; for example ice formations can, first of all, jeopardize the aerodynamics of the nacelle—hence, of the aircraft itself—and, furthermore, they can detach themselves during the flight, thus hitting the components of the engine assembly housed inside the nacelle and jeopardizing the safety of the flight. For this reason, nacelles are provided with anti-icing devices, which are suited to generate heat in the nacelle, so as to counter the formation of ice on its surface.

Traditionally, in the aeronautical field, anti-icing devices are used, which substantially work in a pneumatic manner by conveying the flow of hot air generated by the engine, which tends to flow out of the nacelle, towards the above-mentioned lip. To this regard, ducts of the so-called “D-duct” type are obtained in an annular hollow space defined between a double wall of the cowling, in correspondence to the lip of the nacelle. For example, in this technical field it is widely known to introduce into the hollow space defined by the above-mentioned duct a tubular element, which annularly develops therein and is laterally provided with a plurality of nozzles, which deliver hot air, which, in turn, is drawn through proper passages obtained in the nacelle. The type of tube described above is known, in the technical field, as “Piccolo tube”. The hot air delivered prevents ice from building up, since it causes the water hitting the lip of the nacelle to completely evaporate.

The U.S. Pat. No. 7,291,815 is relative to a built-in system, which, in a nacelle of an aircraft, is adapted to simultaneously fulfill the anti-icing function and the acoustic absorption function.

Among the embodiments described in the U.S. patent mentioned above, a nacelle is described, which is manufactured according to the preamble of the appended independent claim, namely has a casing or cowling having a substantially tubular shape and comprising:
an outer barrel and an inner barrel, and
a coupling edge or lip, which is frontally arranged and radially connects said walls;
said system comprising a panel structure having:
electrically conductor means, adapted to generate heat when they are flown through by an electric current, and
a sound attenuating layer.

In the above-mentioned U.S. patent, the panel system is arranged frontally on the nacelle, shaping it above the lip of the cowling. In this way, the above-mentioned device is able to perform an acoustic attenuation of incident sound waves, besides replacing the function of the pneumatic anti-icing devices of the traditional type.

### SUMMARY OF THE INVENTION

The object of the present invention is to provide an improved nacelle.

According to the present invention, this and other objects are reached by means of an element for acoustic absorption according to appended claim 1, which is independent.

The appended claims are an integral part of the technical teaches provided in the present description concerning the invention. In particular, the appended claims define some preferred embodiments of the present invention and describe optional technical features.

### BRIEF DESCRIPTION OF THE DRAWINGS

Further features and advantages of the present invention will be best understood upon perusal of the following detailed description, which is provided by way of example and is not limiting, with reference to the accompanying drawings, which specifically show what follows:

FIG. 1 is a longitudinal section of an explanatory embodiment of a nacelle according to the present invention;

FIG. 2 is a prospective and partially exploded view of a built-in system for anti-icing protection and acoustic absorption of the nacelle shown in FIG. 1; and

FIG. 3 is a prospective and partial view of a further explanatory embodiment of a nacelle according to the present invention.

### DETAILED DESCRIPTION OF THE INVENTION

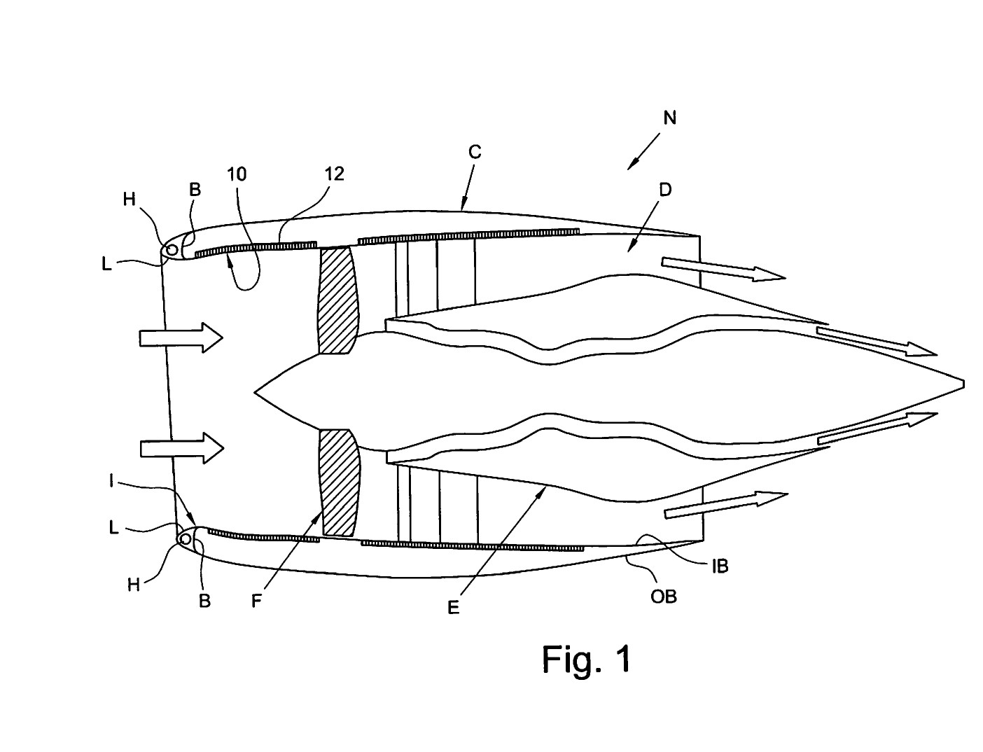

With reference in particular to FIG. 1, number 10 indicates, as a whole, an explanatory embodiment of a built-in system for anti-icing protection and acoustic absorption.

As shown in FIG. 1, in this embodiment, built-in system 10 is suited to be mounted on a nacelle N.

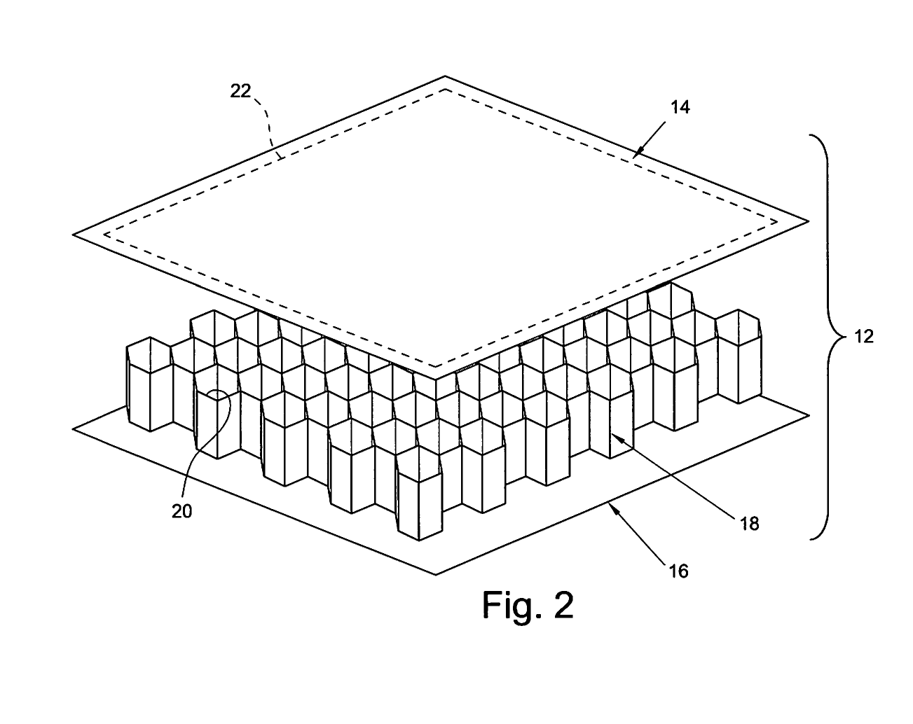

With reference in particular to the embodiment shown in FIG. 2, the above-mentioned built-in system 10 comprises a panel structure 12 having:
electrically conductor means 22, adapted to generate heat when they are flown through by an electric current, and
a sound attenuating layer, for example a cell-like layer 18 defining a reticular structure, which has a plurality of hollow cells 20, adapted to cause the sound waves affecting system 10 to resonate inside their barrels. Preferably, built-in system 10 comprises:
a face-sheet 14, which is operatively arranged in nacelle N in a radially inner position and, at least in an area of its, is sound permeable (in particular, it can be flown through by a prevailing portion of the sound waves hitting it)
a back-sheet 16, which is operatively arranged in the nacelle N in a radially outer position and is bearing as well as substantially sound reflecting (in particular, it can reflect a prevailing portion of the sound waves hitting it).

Hence, back-sheet 16 is adapted to perform a structural support function, so as to allow panel structure 12 to generally keep the desired shape or profile, when it is installed on nacelle N. For example, back-sheet 16 can be made of a composite material, such as a material having a matrix made of epoxy resin with a reinforce including glass fiber. If necessary, back-sheet 16 can also comprise sheets of portions made of insulating material, so as to prevent the electric current flowing through means 22 from propagating, in any way, through undesired regions of cowling C of nacelle N.

In the embodiment shown, sound attenuating layer 18 is interposed, in a sandwich-like manner, between face-sheet and back-sheet 16. In particular, when the sound attenuating layer comprises a cell-like layer 18, the latter is able to cause the sound waves entering through face-sheet 14 and reflected by back-sheet 16 to resonate, thus providing a sound attenuation.

In this technical field, face-sheet 14 and back-sheet 16 can also be considered as an exposed layer and a non-exposed layer, respectively.

In particular, when built-in system 10 is combined with nacelle N, electrically conductor means 22 are able to operate, in use, as an anti-icing device, so as to heat up nacelle N, thus countering the drawbacks arising from the the formation of ice therein.

As explained more in detail below, the use of the above-mentioned built-in system 10 in a nacelle N permits a convenient design flexibility. As a matter of fact, when a nacelle N is designed, in order for inner barrel IB of cowling C to support built-in system 10, one can cause the nacelle N:
not to have a dedicated anti-icing device of the pneumatic type, which is typically installed in correspondence to lip L, so as to at least partially avoid the drawbacks concerning sizes, weight and performance degradation; or
to have, in addition to electrically conductor means 22, a dedicated anti-icing device of the pneumatic type (e.g. of the type discussed above in the description of the technical background), so as to increase the heating action generally exerted in nacelle N.

If lip L is provided with the anti-icing device of the pneumatic type, panel structure 12 of system 10 preferably extends so as to make up lip L itself, in order to provide the latter with a local heating thanks to electrically conductor means 22.

Preferably, means 22 are built-in in panel structure 12. More preferably, means 22 are built-in face-sheet 14.

Electrically conductor means 22 comprise an electrically conductor material, which is suited to be flown through by an electric current, so as to deliver a heat power, in particular in a radial manner towards the inside of nacelle N.

In a preferred embodiment of the present invention, face-sheet 14 comprises a sheet made of a composite material that is acoustically porous, which means that it is permeable to incident sound waves or can be flown through by them. Said composite material sheet comprises a matrix in which a reinforce is embedded, which comprises the above-mentioned electrically conductor material making up the heating device.

Preferably, the above-mentioned matrix is made of an electrically insulating material.

By way of example, the electrically conductor material making up the above-mentioned reinforcement comprises oblong bodies or fibers made of an electrically conductor material, such as for example carbon fibers, which can be flown through by a suitable electric current, which is supplied by an external electric generator, which is controlled according to predetermined criteria.

Optionally, the above-mentioned reinforce comprises a plurality of oblong bodies or fibers made of the above-mentioned electrically conductor material, which can be arranged according to a predetermined pattern (for example, arranged in meshes or defining rings that are substantially centered around the axis of cowling C of nacelle N) or oriented according to a substantially casual arrangement.

By way of example, built-in structure 10 can be designed so as to create a heating system divided into areas of inner barrel IB of cowling C, so as to obtain a temperature that is overall substantially homogeneous and to optimize the heating electric power delivered. For example, the density of the oblong bodies or fibers provided in face-sheet 14 can axially decrease from the area of lip L towards the area of the engine assembly (in particular of fan F), so as to generate, given the same voltage delivered by the electric generator, a greater heat close to the front section of the cowling and a smaller heat close to the engine assembly. Alternatively, in order to obtain a similar effect, one can substantially provide, along face-sheet 14, the same density of oblong bodies or fibers, but design electric connections to the electric generator that are adapted to supply a greater voltage close to lip L, which is basically colder, and a smaller voltage close to the engine assembly, which is basically hotter.

In a further preferred embodiment of the present invention, face-sheet 14 is also at least partially covered by a coating 24 made of a corrosion-resistant material. Preferably, above-mentioned coating 24 can have a plurality of perforations, for example micro-holes, adapted to cause it to be acoustically porous, just like face-sheet 14 underneath. Alternatively, the metal material sheet comprises—and is preferably made of—a fine mesh net.

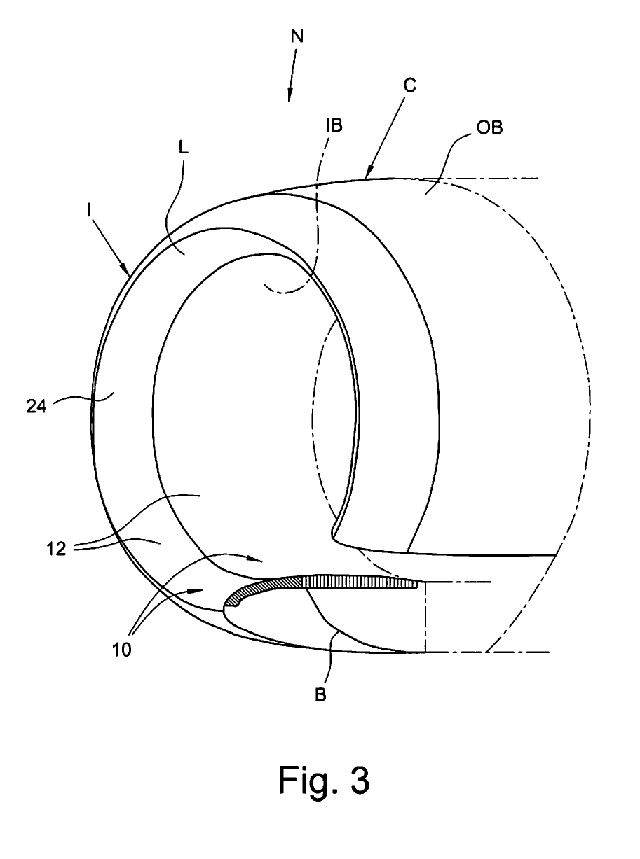

For example, the above-mentioned corrosion-resistant coating 24 can be made of at least one of the materials selected from the group consisting of: properly treated aluminum alloy and titanium alloy, and stainless steel. As described more in detail below, this feature is particularly—but not exclusively—advantageous when panel structure 12 is used in a nacelle N to replace the pneumatic heating devices of the traditional type that are built-in in lip L of inlet I of cowling C, for example in the solution according to the configuration shown in FIG. 3. In particular, the above-mentioned coating 24 helps avoid corrosion phenomena that can occur on face-sheet 14 of panel structure 12, in particular when face-sheet 14 at least partially replaces—or covers—lip L of inlet I defined by cowling C.

Coating 24 can extend on entire face-sheet 14 of panel structure 12, thus defining its entire surface that is operatively arranged in a radially inner position of cowling C. Alternatively, coating 24 can extend only on the part of face-sheet 14 that is arranged in correspondence to lip L, thus making it up or covering it.

As far as the production of built-in system 10 is concerned, panel structure 12 (including electrically conductor means 22) is preferably manufactured as one single piece, without the use of joints, for example by using a procedure that is similar to the one described in patent no. EP 2 017 077 A2, which is owned by the Applicant.

In particular, panel structure 12 can be manufactured by means of a production process comprising a step for the lamination of face-sheet 12 (including electrically conductor means 22, which, for example, are preliminarily built-in or embedded in the face-sheet), a step to apply cell-like layer 18 onto face-sheet 14, a step for the lamination of back-sheet 16, a polymerization step (in particular, a so-called co-curing step) for the polymerization of the assembly consisting of layers 14, 16, 18 arranged one on top of the other, and, if necessary, a step for the perforation of the face-sheet 14—which, in turn, can be at least partially covered by coating 24—so as to cause it to be sound permeable or crossable.

In FIG. 1, built-in system 10 is mounted on nacelle N.

In this embodiment, nacelle N comprises a casing or cowling C with an aerodynamic shape. In particular, cowling C has a substantially tubular shape, for example a barrel-like or a cask-like shape. Preferably, the cowling has a longitudinal section defining an aerodynamic profile with a wing-like shape.

More in detail cowling C has an air inlet I, from which a through cavity develops, which extends in a substantially axial direction.

The structure of cowling C comprises an outer barrel OB and an inner barrel IB. Outer barrel OB and inner barrel IB define respective substantially cylindrical shapes, which are radially spaced apart and enclose, between them, a hollow space or annular space.

Cowling C houses, through the through cavity and downstream of inlet I, an engine assembly of the jet type, which is adapted to receive air from the air inlet and to accelerate it, so as to generate a thrust. In particular, the engine assembly is designed as a structure of the so-called turbo-fan type, which means that it comprises:
a fan F, which is suited to accelerate the air flow flowing in through inlet I, and
an engine E, which is arranged downstream of fan F.

In the embodiment shown, an annular region or by-pass duct D is defined between cowling C and engine E, said by-pass duct D being structured so as to convey the air fraction flowing through fan F that is not destined to flow through engine E.

Clearly, the structure and the operation of the above-mentioned engine assembly, which is schematically shown in FIG. 1, are known to person skilled in the art and, for the sake of brevity, they will not be described in detail in the present description. In the above-mentioned figure, the air flows flowing through nacelle N are shown, by mere way of example, with a series of arrows.

As already mentioned above, inlet I is provided with a lip L, which is defined by the connection between the above-mentioned outer barrel OB and the above-mentioned inner barrel IB. In particular, lip L has an axial section that defines a C-shape, whose cavity faces backwards.

When system 10 is applied to nacelle N, inner barrel IB is the one that supports the above-mentioned system 10. In particular, panel structure 12 is supported by inner barrel IB and, preferably, it is included in inner barrel IB and, more preferably, it makes up at least a portion of the above-mentioned inner barrel IB. Clearly, when used in association with nacelle N, panel structure 12 has face-sheet 14 facing inwards, which means that it faces the inner cavity defined by inner barrel IB of cowling C.

In the configuration shown by way of example in FIG. 1, the above-mentioned panel structure 12 ends before lip L of inlet I, because lip L houses a pneumatic heating device H in the hollow space or annular channel (making up a so-called D-duct) defined between barrels IB, OB of cowling C (in particular, also delimited on the rear side by a bulkhead B).

In this way, nacelle N that is shown by way of example in FIG. 1 is provided with a “hybrid” heating system, in which a pneumatic heating device H of the traditional type (in particular, of the so-called “Piccolo tube” type) and electrically conductor means 22 supported by element 10 coexist. This configuration is particularly useful to obtain a heating system with performances that are higher than the ones known to a person skilled in the art, especially when more biding rules will be enforced in the aeronautical field (for example, in conditions known as “Supercooled Large Droplet Icing Conditions”).

In the embodiment shown in FIG. 1, the barrel portion made up of panel structure 12 ends before the area of nacelle N where fan F is housed. In further embodiments, though, this barrel portion can extend up to the above-mentioned area, so as to surround fan F.

With reference in particular to FIG. 3, a nacelle N is shown, which is an alternative to the one shown in FIG. 1. In this nacelle N, especially in its inner barrel IB, element 10—with its panel structure 12—extends so as to be supported by lip L, preferably so as to be included in lip L and, more preferably, so as to make up at least part of lip L itself. In this way, element 10 can operate as a running-wet system, in which the water particles deriving from the melting of the ice formed inside cowling C are kept at a liquid state substantially for the entire extension of air intake I up to fan F and are subsequently expelled by fan F itself.

Optionally, as mentioned above, in case at least a portion of the face-sheet 14 helps define lip L, this portion is made of or covered with a corrosion-resistant material, for example at least one of the materials selected from the group consisting of: properly treated aluminum alloy and titanium alloy, and stainless steel.

Preferably, panel structure 12 makes up the portion of inner barrel IB that extends from lip L up to the area where fan F is housed. For example, panel structure 12 making up the portion of inner barrel IB defines lip L and, in particular, can surround fan F.

More preferably, panel structure 12 makes up entire inner barrel IB of cowling C and lip L, thus crating the whole assembly as one single piece. These features allow the overall nacelle manufacturing process to the simplified as well as the area ensuring an acoustic attenuation to be extended.

According to some analyses carried out by the Applicant, several performance advantages due to element 10 according to the present invention have been observed.

For example, when replacing a pneumatic anti-icing device of the traditional type with an electric heating device incorporated in built-in system 10 according to the present invention, weight can be reduced by 90%, whereas, for entire lip L of the inlet I, this weight reduction can reach 20%.

Furthermore, when replacing the pneumatic anti-icing device of the traditional type (which operates so as to cause the substantially complete evaporation of the water particles affecting lip L) with the electric heating device incorporated in built-in system 10 according to the present invention (which, on the other hand, operates as a running-wet system to keep the water particles at a temperature that is compatible with their liquid state), the power reduction, which is necessary to avoid the presence of ice, can reach up to 23% for a medium-sized nacelle N.

In particular, in this way, the structure of lip L can benefit from the advantages associated with the technology known as “zero-splice liner”, which so far has been used only in the panel structure of the elements for acoustic absorption known in the technical field.

Owing to the above, according to an advantageous embodiment of the invention, system 10—in particular with its panel structure 12—can internally make up inner barrel IB, thus creating it as one single piece. Furthermore, according to a further advantageous embodiment of the invention, system 10—in particular with its panel structure 12—can internally make up the above-mentioned inner barrel IB together with lip L, thus creating them both as one single piece. Therefore, in both the above-mentioned embodiments, inner barrel IB—if necessary with lip L—is manufactures in a structurally continuous manner, with substantial advantages especially in terms of the structure of the entire nacelle. Naturally, the principle of the present invention being set forth, the embodiments and the implementation details can be widely changed with respect to what described above and shown in the drawings as a mere way of non-limiting example, without in this way going beyond the scope of protection provided by the accompanying claims.

1. Nacelle for an aircraft, provided with a built-in system for anti-icing protection and acoustic absorption; said nacelle comprising:
a casing or cowling having a substantially tubular shape and comprises:
an outer barrel and an inner barrel, and
a coupling edge or lip frontally arranged and radially connecting said barrels;
said system comprising a panel structure having:
electrically conducting means, for generating heat when an electric current passes through the electrically conducting means, and
a sound attenuating layer;
wherein said inner barrel houses said system;
wherein said coupling edge or lip contains a pneumatic heating device.

2. Nacelle according to claim 1, wherein said lip houses said pneumatic heating device in a hollow space or annular channel defined between said barrels.

3. Nacelle according to claim 2, wherein said pneumatic heating device is a Piccolo-tube type device.

4. Nacelle according to claim 1, wherein said sound attenuating layer comprises a cell-like layer defining a reticular structure, which has a plurality of hollow cells, for causing sound waves affecting said system to resonate inside said barrels.

5. Nacelle according to claim 1, wherein said system forms at least a portion of said inner barrel.

6. Nacelle according to claim 1, wherein said system forms or lies on at least a portion of said inner barrel, which axially extends from said coupling edge or lip up to an area for housing an engine assembly of said nacelle.

7. Nacelle according to claim 6, wherein said system internally comprises said inner barrel creating one single piece.

8. (canceled)

9. Nacelle according to claim 1, wherein said panel structure further comprises:
a face-sheet, which is arranged in a radially inner position and, at least in an area of said face sheet is sound permeable;
a back-sheet, which is arranged in a radially outer position and is bearing as well as substantially sound reflecting;
said sound attenuating layer being interposed, in a sandwich-like manner, between said face-sheet and said back-sheet and being able to attenuate sound waves entering through said face-sheet and reflected by said back-sheet.

10. Nacelle according to claim 9, wherein said face-sheet comprises said electrically conducting means.

11. Nacelle according to claim 10, wherein said face-sheet is a sheet made of an acoustically porous composite material and comprising a matrix, made of an electrically insulating material, in which a reinforcement is embedded, which includes said electrically conductor material.

12. Nacelle according to claim 9, wherein said face-sheet is at least partially covered by a coating made of a corrosion-resistant material.
